(19) United States
(12) Patent Application Publication
(10) Pub. No.: US 2013/0197941 A1
(43) Pub. Date: Aug. 1, 2013

(54) EMERGENCY RESPONSE HEALTH INFORMATION SYSTEM, ACCESS DEVICE, PATIENT TAG AND METHOD FOR SECURE ACCESS OF HEALTH INFORMATION

(71) Applicant: Michael Cochran, Aliso Viejo, CA (US)

(72) Inventor: Michael Cochran, Aliso Viejo, CA (US)

(21) Appl. No.: 13/753,363

(22) Filed: Jan. 29, 2013

Related U.S. Application Data
(60) Provisional application No. 61/592,343, filed on Jan. 30, 2012.

(51) Int. Cl. G06F 19/00; G06Q 50/22

(52) U.S. Cl. CPC G06F 19/322; G06Q 50/22
USPC 705/3; 705/2

(57) ABSTRACT

In one embodiment, an emergency response health information system includes: (a) a patient tag; (b) an access device; and (c) an information processing system. In one embodiment, the patient tag includes: (a) an indicia; and (b) a unique patient identifier. In one embodiment, the access device is configured to read the indicia and transmit the indicia to the information processing system. After a secure connection is established between the access device and the information processing system, the access device enables a user to enter a unique patient identifier and transmits the entered unique patient identifier to the information processing system. In one embodiment, the information processing system is configured to, after the entered unique patient identifier has been transmitted, transmit, to the access device, a first health information component.

### BACKGROUND

The medical health records ecosystem has become fragmented with many health care providers maintaining a patient's medical and health history. Complex drug interactions, recent test results and/or medical device settings are often critical to proper diagnosis and treatment. In the event of an emergency, the patient may not able to respond to verbal or written communication due to serious injury or illness leaving the patient non-responsive or unconscious. Health care providers can be forced to make educated guesses on limited information that is provided. As a result, health care providers that are not familiar with the patient's health history may prescribe treatment that may have an adverse effect on the patient's health. In these situations quick access to the patient's health information by first responders, emergency room, urgent care and/or health care professionals can make the difference of life or death.

Communication of patient health information is protected under Health Insurance Portability and Accountability Act of 1996 (HIPAA). HIPAA places strict regulations including restrictions to the access and dissemination of Electronic Protected Health Information (EPHI) to Health Care Providers. Section 1173(d) of the HIPPA provides that “covered entities that maintain or transmit health information are required to maintain reasonable and appropriate administrative, physical, and technical safeguards to ensure the integrity and confidentiality of the information and to protect against any reasonably anticipated threats or hazards to the security or integrity of the information and unauthorized use or disclosure of the information.”

Accordingly, a need exists for further development of systems and methods for quickly and securely providing health information.

### SUMMARY

In one embodiment, an emergency response health information system includes (a) a patient tag including: (i) an indicia; and (ii) a unique patient identifier; (b) an access device; and (c) an information processing system. In one embodiment, the access device includes: (a) a first processor; (b) a reading device operatively coupled to the first processor; (c) a first input device operatively coupled to the first processor; and (d) a first memory device storing instructions.

In one embodiment, when executed by the first processor, the first instructions cause the first processor, in cooperation with the optical scanner, the first input device and the first memory device, to: (i) read the indicia and transmit the indicia to the information processing system; (ii) after a secure connection is established between the access device and the information processing system, enable a user to enter a unique patient identifier; and (iii) transmit the entered unique patient identifier to the information processing system.

In one embodiment, the information processing system includes: (a) a second processor; and (b) a second memory device storing second instructions.

In one embodiment, when executed by the second processor, the second instructions cause the second processor, in cooperation with the second memory device, to, after the entered unique patient identifier has been transmitted, transmit, to the access device, a first health information component.

In one embodiment, the indicia includes a Uniform Resource Locator (URL) and a directory structure. In one embodiment, the unique patient identifier is a readable set of alpha-numeric characters.

In one embodiment, the reading device includes a camera.

In one embodiment, the first health information component includes at least one of name, height, weight, age, phone number, address, emergency contact, medical conditions, medication, allergies, primary and specialist physicians, procedures, operations, test results, advanced directives, family history, health history, cognitive and perceptional limitations, nutrition/metabolic concerns, values/beliefs/spiritual care.

In one embodiment, the second instructions, when executed by the second processor, cause the second processor, in cooperation with the access device, to: (a) enable the user to enter a second identifier, the second identifier being different from the unique patient identifier; and (b) in response to the second identifier being authenticated, provide, to the access device, a second health information component, the second health component being different from the first health information component.

In one embodiment, the second identifier includes an administrative access identifier.

In one embodiment, the second health component includes information regarding at least one of past procedures, test results, and advanced directives.

In one embodiment, a method of operating an emergency response health information system includes: (a) causing an access device to read indicia from a patient tag and transmit the indicia to an information processing system; (b) after establishing a secure connection the access device and the information processing system, enabling a user to enter a unique patient identifier which is located on the patient tag; (c) causing the access device to transmit the entered unique patient identifier to the information processing system; and (d) after the entered unique patient identifier has been transmitted, causing the information processing system to transmit, to the access device, a first health information component.

In one embodiment, the method includes: (a) causing the access device to enable the user to enter a second identifier, the second identifier being different from the unique patient identifier; and (b) in response to the second identifier being authenticated, causing the information processing system to provide, to the access device, a second health information component, the second health component being different from the first health information component.

In one embodiment, the access device includes: (a) a first processor; (b) a reading device operatively coupled to the first processor; (c) a first input device operatively coupled to the first processor; and (d) a first memory device storing instructions. In one embodiment, when executed by the first processor, cause the first processor, in cooperation with the optical scanner, the first input device and the first memory device, to: (a) read an indicia from a patient tag; (b) transmit the indicia to an information processing system; (c) after a secure connection is established between the access device and the information processing system, enable a user to enter a unique patient identifier; (d) transmit the entered unique patient identifier to the information processing system; and (e) receive, from the information processing system, a first health information component.

Additional features and advantages are described herein, and will be apparent from the following Detailed Description and figures.

### BRIEF DESCRIPTION OF THE FIGURES

FIG. 1A illustrates a high level schematic diagram of one embodiment of an emergency response health information system.

FIG. 1B illustrates a schematic diagram of one embodiment of the computing devices of the system, illustrating the processors, instructions and memory devices.

FIG. 1C is a flowchart showing one example of a process for providing health information components.

FIG. 2 illustrates a schematic block diagram of one embodiment of the patient database, illustrating a plurality of access levels and a plurality of health information components.

FIGS. 3A, 3B and 3C illustrate perspective views of one embodiment of the patient tag, illustrating the patient tag having a protective area and a public identification strip.

FIG. 3D illustrates a perspective view of one embodiment of the patient tag, illustrating the patient tag including a medical alert bracelet.

FIG. 3E illustrates a perspective view of one embodiment of the patient tag, illustrating the patient tag including a necklace.

FIG. 3F illustrates a perspective view of one embodiment of the patient tag, illustrating the patient tag including an ID entrance badge.

FIG. 4 illustrates a schematic diagram of one embodiment of the access levels, illustrating each access level being associated with different access identifiers.

FIG. 5 illustrates a schematic diagram of one embodiment of the system, illustrating the system's access logs and the health care provider authorized access database.

### DETAILED DESCRIPTION

In one embodiment, the systems and methods described herein can collect, consolidate and electronically protect a patient's health information, and then disseminate or provide the patient's electronic protected health information (EPHI) in the event of an emergency or time critical situation. The system may provide the EPHI in the event that the patient is unable to respond to verbal or written communication due to serious injury or illness that may leave the patient nonresponsive or unconscious. In one embodiment, the system maintains and protects an accurate record of the patient's EPHI and enables a user to have access to it anytime, anywhere in the world where Internet access is available. In one embodiment, the system provides electronic security that is responsive and adaptive to online attackers. In one embodiment, the system enables the patient to control access to their EPHI.

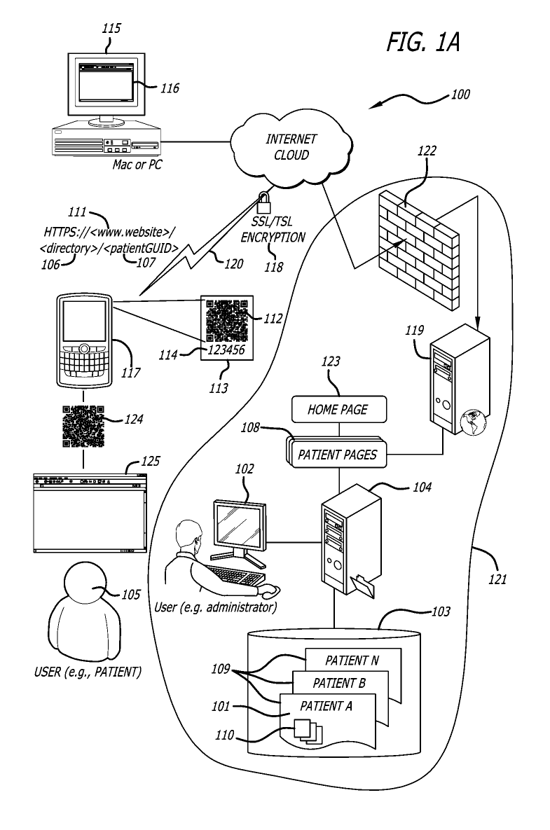

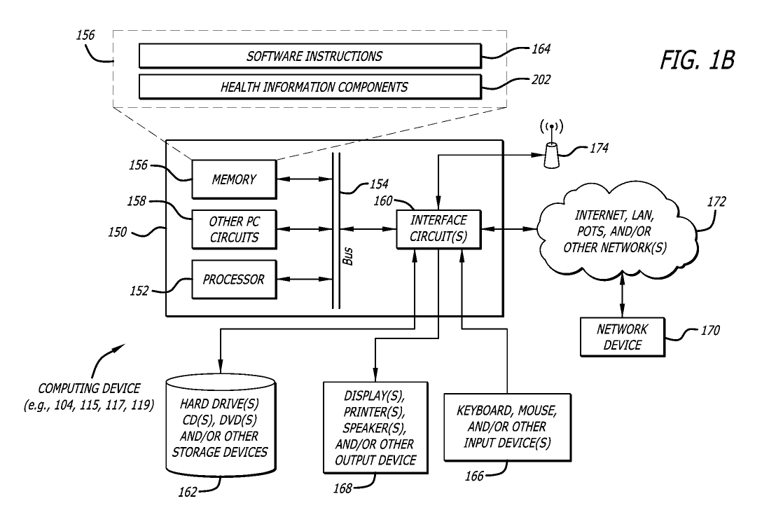

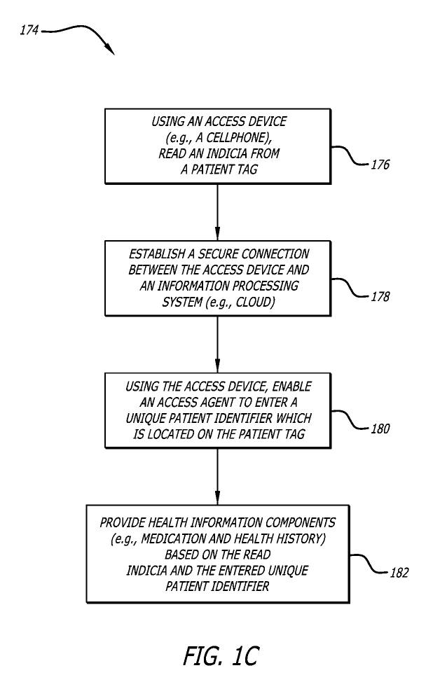

The systems described herein can be readily realized in a network communications system. A high level block diagram of an exemplary network communications system 100 is illustrated in FIG. 1. In one embodiment, system 100 includes patient tag 113, access device 117, and information processing system or cloud or Internet hosting service 121. Access device 117 may communicate with cloud 121 via a connection to one or more networks such as the Internet and/or some other data network, including, but not limited to, any suitable wide area network or local area network. It should be appreciated that any of the devices described herein may be directly connected to each other instead of over a network. In this embodiment, cloud 121 includes database server 104 and web server 119. In one alternative embodiment, information processing system 121 is a single server.

A detailed block diagram of an example computing device (e.g., database server 104, PC 115, access device 117 and/or web server 119) is illustrated in FIG. 1B. Each computing device may include a server, a personal computer (PC), a personal digital assistant (PDA), and/or any other suitable computing device. Each computing device preferably includes main unit 150 which preferably includes one or more processors 152 electrically coupled by address/data bus 154 to one or more memory devices 156, other computer circuitry 158, and one or more interface circuits 160. Processor 152 may be any suitable processor.

Memory 156 preferably includes volatile memory and/or non-volatile memory. Preferably, memory 156 and/or another storage device 162 stores software instructions 164 that interact with the other devices in system 100 as described herein. These software instructions 164 may be executed by the processor 152 in any suitable manner. Memory 156 and/or another storage device 162 may also store digital data indicative of documents, files, programs, web pages, etc. retrieved from another computing device and/or loaded via an input device 166.

In one example, memory device 156 stores software instructions 164 and health information components 202 for use by system 100 as described in detail below. It should be appreciated that any type of suitable data structure (e.g., a flat file data structure, a relational database, a tree data structure, etc.) may be used to facilitate implementation of the methods and apparatus disclosed herein.

One or more displays, printers, speakers, and/or other output devices 168 may also be connected to main unit 150 via the interface circuit(s) 160. Display device 168 may be a cathode ray tube (CRTs), liquid crystal displays (LCDs), or any other type of display. Display device 168 generates visual displays of data generated during operation of the computing device. For example, display device 168 may be used to display web pages received from cloud 121. The visual displays may include prompts for human input, run time statistics, calculated values, data, etc.

Each computing device may also exchange data with other network devices 170 via a connection to network 172. The network connection may be any type of network connection, such as an Ethernet connection, digital subscriber line (DSL), telephone line, coaxial cable, etc.

A flowchart of an example process 174 for providing health information components is presented in FIG. 1C. Preferably, process 174 is embodied in one or more software programs which are stored in one or more memories and executed by one or more processors. Although process 174 is described with reference to the flowchart illustrated in FIG. 1C, it should be appreciated that many other methods of performing the acts associated with process 174 may be used. For example, the order of many of the steps may be changed, some of the steps described may be optional, and additional steps may be included.

Using an access device, an indicia is read from a patient tag (block 176). In one embodiment, the patient tag includes the indicia (e.g., a barcode) and a unique patient identifier (e.g. a readable set of alpha-numeric characters). In one embodiment, the patient tag is configured to be worn as a necklace.

Next, system 100 establishes a secure connection between the access device and the information processing system (e.g., cloud) (block 178).

After the secure connection is established, using the access device, an access agent is enabled to enter the unique patient identifier which is located on the patient tag (block 180). This protects against a “man in the middle” attack on the internet from a remote attacker “snooping” the system's website for internet packets containing the patient's unique patient identifier.

Next, system 100 provides health information components based on the read indicia and the entered unique patient identifier (block 182). In one embodiment, the provided health information is based on a predetermined level of access. For example, in one embodiment, after the unique patient identifier is successfully authenticated, the system provides the access device with health information available for a first level of access (e.g., public access level). In one embodiment, for a second level of access (e.g., health care access level), the system provides the access device with additional health information based on an additional identifier (e.g., a health care provider identifier).

Referring to FIG. 1, in one example embodiment, system 100 includes: (a) patient tag 113; (b) access device 117; and (c) information processing system or cloud 121. In this example embodiment, cloud 121 includes database server 104 and web server 119. In the event a patient has an accident or becomes seriously ill rendering them unconscious or non-responsive, system 100 enables a first responder to the patient to use access device 117 to scan the patient tag 113 and then, after a secure connection is established, enter unique public identifier 114 to gain access to the patient's EPHI. Therefore, a health care provider can be provided with the health information prior to treating the patient.

### Patient Tag

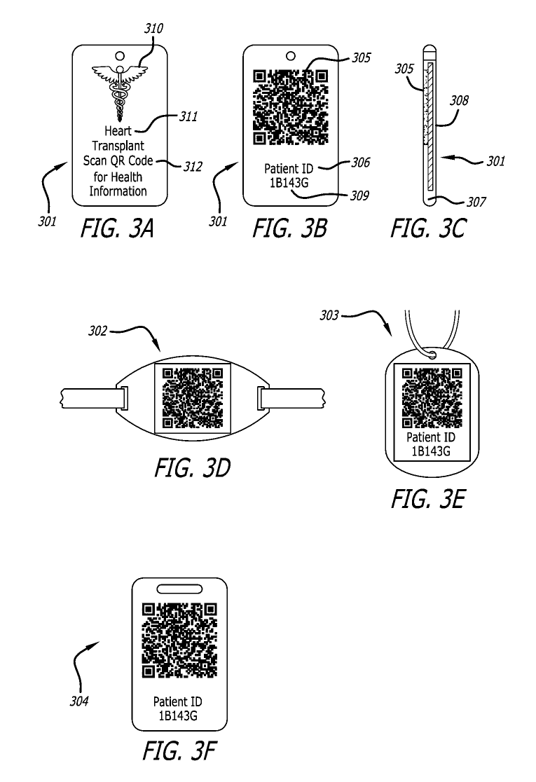

Referring to FIG. 1, patient tag 113 includes indicia 112 and unique patient identifier or public access identifier 114. Indicia 112 is preferably encoded. In one embodiment, indicia 112 includes a Uniform Resource Locator (URL) and/or a directory structure. Referring to FIGS. 3B and 3C, patient tag 301 includes indicia 305. In this embodiment, indicia 305 includes a URL link.

As illustrated in FIG. 1 and FIGS. 3A to 3F, in one embodiment, patient tags 113 and 301 are configured to be carried by a patient. As illustrated in FIG. 3D to 3F, patient tag 301 can include a physical token which can be in the form of medical alert bracelet 302, necklace or dog tag 303, or ID entrance badge 304. Patient tag 113 and 301 can be an access card or any other physical device capable of presenting indicia and a readable set of alpha-numeric characters.

Additional security can be provided by the patient hiding their patient public identifier until required by an emergency situation. The patient may hide their patient public identifier behind a shirt or blouse, on the back side of a bracelet or in a wallet. Hiding the patient public identifier from plain view prevents online attackers from capturing both the patient tag's URL (i.e., the patient unique Web URL) while snooping the system's website and the human readable patient public identification on the patient tag protected by the patient. Because the patient public identifier is generally discovered in the event of an emergency by a human and is entered in at the patient's SSL secured website, an online attacker is prevented from gaining electronic access to the patient identifier online.

Indicia 112 can include PDF417, MicroPDF417, MaxiCode, Data Matrix, QR Code, Aztec, Aztec Mesas, Code 49, EAN-UCC Composite, Snowflake, Dataglyphs, Code 39, Code 128, Codabar, UPC, EAN, Interleaved 2 of 5, Reduced Space Symbology, Code 93, Codablock F, and BC412, Postnet, Planet Code, British Post, Canadian Post, Japanese Post, KIX (Netherlands) Post, OCR-A, OCR-B, Code 11, UPC, EAN, MSI, and/or Code 16K.

Indicia 112 can be added to patient tag 113 by printing, etching or otherwise permanently or temporarily marking patient tag 113.

In one embodiment, unique patient identifier 114 is selectable by user 105 (e.g., patient). In one embodiment, unique patient identifier 114 is human-readable and includes a series of alpha-numeric characters.

In one embodiment, patient tag 301 includes a public identification strip which is configured to be inserted into a protect area. For example, referring to FIG. 3, patient tag 301 includes protect area 308. In this example, public identification strip 307 can be inserted into protect area 308. This protects public identification strip 307 from wear and tear from exposure to elements such as moisture, water or wind and becoming unreadable. To increase security of access to the system should patient identification become known by unwanted persons, organizations or agencies, patient identification strip 307 can be changed by the patient. As illustrated in FIG. 3A, in one embodiment, patient tag 301 includes a universally recognized medical alert symbol 310, medical condition 311 and simplified representation in symbol form or readable, language localized, text 312 to instruct a person how to access the patient's public EPHI. Patient identification strip 307 can be handwritten or computer printed by the patient to help protect their identity from online attackers without access to patient tag 301.

Patient tag 301 can be formed from a durable material such as plastic or metal with clear protected area 305 (e.g., molded plastic).

### Access Device

Referring to FIG. 1, access device 117 includes a cellular phone. It should be appreciated that access device 117 can include other devices, such as, but not limited to, a smartphone (e.g., iPhone, Androde, Windows Mobile, Web OS or similar mobile based phone), a tablet (e.g., Apple iPad®, Samsung Galaxy® or similar wireless mobile computing device), a notebook and/or a stationary computer (e.g., PC and MAC).

In one embodiment, access device 117 includes a camera which is configured to read or scan indicia 112. In one embodiment, said reading or scanning causes an initialization of an access to a URL. Access device 117 can require downloading a scanner application prior to employing certain portions of the processes described herein.

In one embodiment, in operation, access device 117 optically scans indicia 112 and transmits the scanned information (e.g., the encoded indicia) through a wired or wireless network or the Internet to an application running in cloud 121 to call up a secure website.

### Cloud

In one embodiment, cloud 121 enables ubiquitous, convenient, on-demand network access to a shared pool of configurable computing resources (e.g., networks, servers, storage device, applications, and services) that can be rapidly provisioned and released with minimal management effort or service provider interaction.

Referring to FIG. 1, in one embodiment, cloud 121 includes web server 119, database server 104 and patient database 103.

### Web Server

In one embodiment, in response to user 105 (e.g., patient, health care provider, and/or access agent) entering unique patient identifier 114 or a National Provider Identifier (NPI) or a secret identifier, web server 119 authenticates access device 117. In one embodiment, where cloud 121 includes database server 104, secure web server 119 communicates with database server 104 and requests the appropriate level of EPHI from database server 104. Thereafter, secure web server 119 provides the EPHI to access device 117.

### Database Server

In one embodiment, database server 104 maintains or stores a plurality of patient database files 109. In one embodiment, database server 104 includes an access log used by an automated security auditor (ASA) in detecting and protecting the system from malicious attack by hackers. Database server 104 is an application that is written in a relational database management system (RDBMS) such as Structured Query Language (SQL) or Microsoft Office Access. Once the database application is completed it can be hosted on the Cloud.

While the systems and methods described herein are intended primarily for emergency response situations, the systems and methods can be used by a patient to collect, organize and manage all their health information throughout their life. Because certain components of the system are contained on the cloud by a web hosting service, the information can be secured, maintained and backed up per NIST SP800-144 standards. In addition to cloud access and storage, the patient can choose to download their records on a secure USB token device for off-cloud storage at the patient's home or office.

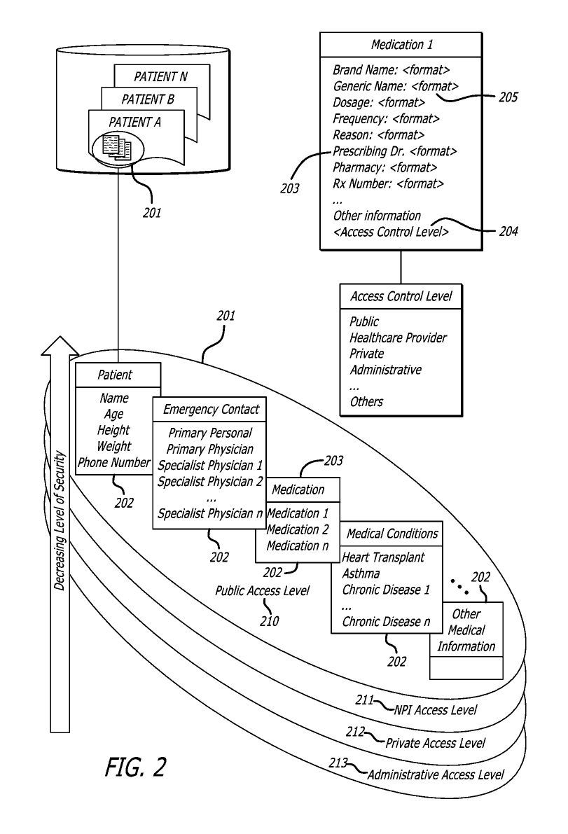

Referring to FIG. 2, in one embodiment, patient database files 108 include various components 202 of the patient's EPHI. In one embodiment, system 100 enables each patient or their authorized agent to set up patient database files with health information each patient wants to maintain. In one embodiment, each EPHI component 202 is associated with or corresponds to an access level assigned by the system (based on user input) that database server 104 reads to determine which EPHI is appropriate to serve to the web server based on the authenticated access level of access device 117.

### Health Information Components

Health information components 202 can include information such as, but not limit to, name, height, weight, age, phone number, address, emergency contact, medical conditions, medication, allergies, primary and specialist physicians, procedures, operations, test results, advanced directives, family history, health history, cognitive and/or perceptional limitations, nutrition/metabolic concerns, values/beliefs/spiritual care, etc.

Referring to FIG. 2, in one embodiment, patient's EPHI database 201 includes health information components 202. In one embodiment, each health component 202 is associated with or corresponds to at least one parameter 203 and an access level control 204. Using parameter 203 and access level control 204, system 100 provides information based on an appropriate authenticated access level. In one embodiment, each component 202 has an associated format 205 that can enable system 100 to display the information in a way that the access agent can understand. While there are many information components available for the patient or their agent to enter in to the patient database, it is at the patient's discretion as to how much information is entered and at what access level the information components are accessible.

In one embodiment, system 100 enables user 105 (e.g., patient) to set the level of security for each health information component 202. In one embodiment, system 100 enables user 105 to set the level when health information components are entered in system 100. In one embodiment, system 100 sets a default access level for each health information component 202.

In one embodiment, the level of security can be change at any time when system 100 is accessed at administrative level 404. In one embodiment, access identifiers (e.g., public access identifier 114, health care provider access identifier 406, private access identifier 407, and/or administrative access identifier 408) can be changed at anytime at the administrative level 404.

### Account Setup

In one embodiment, system 100 enables user 102 (e.g., system administrator) to set up patient account or record 101. In one embodiment, for each patient, system 100 enables user 102 to allocate space in patient database 103 on database server 104. In one embodiment, system 100 assigns a randomly generated globally unique identifier (UID) 106 (or any other suitable unique identification code) to user 105 (e.g., patient). System 100 preferably maintains directory structure 107 to assist in the organization of patient pages 108 and patient database records 109 to enable searching for patient's EPHI database 110. Directory structure 107 and UID 106 are then added to system's website URL 111 address as URL arguments that can be read by the website. The URL and associate arguments are then encoded into indicia 112.

Patient's EPHI database 110 can be set up using a plurality of different devices. In one embodiment, system 100 enables user 105 (or their agent) to initially set up patient's EPHI database 110 which includes the patient's EPHI. In one embodiment, patient's EPHI database 110 is set up using personal computer 115 with internet browser 116 (e.g., Microsoft Internet Explorer®, Firefox®, and/or Apple's Safari®). In one embodiment, patient's EPHI database 110 is set up using access device 117. In one embodiment, patient's EPHI database 110 is set up by a phone interview with the system administrator 102. In one embodiment, patient 105 is prompted for information the system has been programmed to receive.

In one embodiment, patient's database 110 is dynamically linked and can be expanded as required to hold more health information. In one embodiment, system 100 enables user 102 to enter free form text into a notes section. This feature can be used to enter information which may not be prompted for by system 100.

In one embodiment, the patient database securely stores a plurality of patient accounts or records belonging to a plurality of different patients. For example, in one embodiment, patient database 103 stores the patient EPHI along with other member patient accounts or records 109 in the system.

In one embodiment, database records 109 are accessed through SSL 118 protected Internet Web Server 119 (e.g., HPPTS://) hosted on Internet hosting service 121. Hosting service 121 provides high reliability, high available access to the Website and EPHI database. Hosting service 121 can also provide additional electronic security 122 (such as denial of service, hacking, etc.) and physical security and provides for backup and recovery. This is commonly referred to as hosting on the cloud. Preferably, certain components of the system are hosted on the cloud by a provider that is NIST SP 800-144 compliant.

### Account Access

Using a wired or wireless internet connection 120, access device 117 accesses the patient's EPHI. The wireless internet connection may be over WiFi (i.e., IEEE 208.11 series), WLAN, WWAN or on a mobile phone carrier (e.g., AT&T, Version, Sprint, etc.) with a data plan.

In one embodiment, system 100 is directed to patient's page 108 by loading home page 123 and reading associate directory structure 107 and GUID arguments 106. System 100 can then provide patient's page 108 to access device 117 to provide to the user (e.g., access agent).

System 100 can then prompt the user (e.g., access agent) to enter one of a plurality of access identifiers. For example, in one embodiment, the system prompts the access agent to enter one of, but not limited to, the following access identifiers: (a) public access identifier 114; (b) national provider identifier 406; (c) private access identifier 407; and (d) administrative access identifier 408. The access agent then enters the appropriate access identifier into access device 117. Because access device 117 is already connected to a secure website, the access identifier is sent securely to the information processing system or apparatus.

### Access Levels

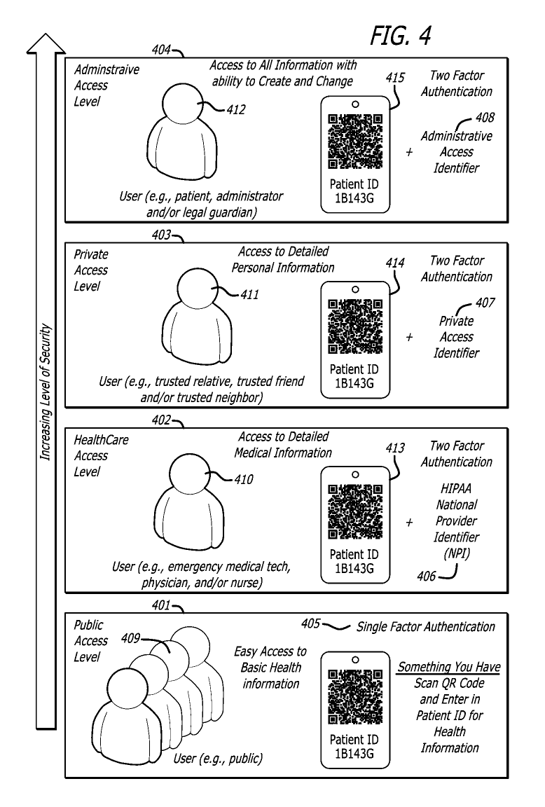

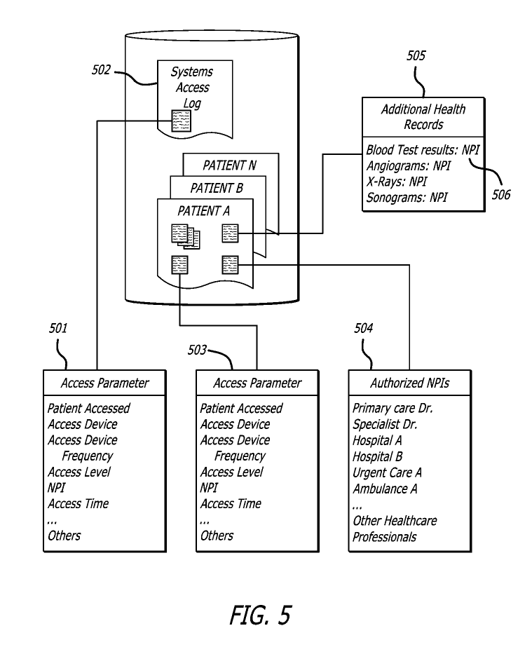

In one embodiment, system 100 defines a plurality of access levels which correspond to a plurality of unique identifiers. Referring to FIG. 2, in one embodiment, the plurality of authorized access levels include, but are not limited to, public access level 210, NPI access level 211, private access level 212 and administrator access level 213. Referring to FIG. 4, in this embodiment, system 100 includes the following four access levels: (i) public access level 401; (ii) health care access level 402; (iii) private access level 403; and (iv) administrative access level 404.

In one embodiment, each access level has a different level of security based on the availability of their respective unique identifier.

In one embodiment, prior to accessing system 100, system 100 enables the patient to control a plurality of authorized access levels. The access levels can be controlled by the patient, with administrator access by setting various access control levels 204 for each health information component 202.

In one embodiment, unique public identifier 114 is available to anyone who has the ability to read patient tag 113 or 301.

In one embodiment, the unique public identifier is generated based on Global Positioning System (GPS). In one example embodiment, the access device employs a custom optical reader application. In one example embodiment, using the custom optical reader application, the system can use the current location based on GPS coordinates read from the access device to serve as the unique public identifier. This would ensure that the information is only accessed while in the corresponding presence of a particular location such as a hospital, museum, National Park, National Monument or other specific location. The GPS readings can be used in conjunction with, or without a private identifier.

In one embodiment, once an access has occurred, system 100 enables the patient to change public identifiers to prevent reoccurring access through the previous patient identifier.

In one embodiment, the system changes the public identifier on a periodic basis, such as daily, weekly, or monthly to prevent access device users from capturing an image of the indicia and accessing the information at another time. Museums, National Parks, National Monuments, and other guided tours could then protect access to their proprietary information by customers at a later time.

In one embodiment, health care access identifier 406 is based on a national health care provider identifier (e.g., HIPPA's NPI database). In one embodiment, private access identifier 407 is known only by trusted persons. In one embodiment, administrator access identifier 408 is only known by the patient or trusted agent or guardian.

### Public Access Level

In one embodiment, in response to scanning indicia 112 and then entering public access identifier 114, system 100 enables access to public access level 403. For example, referring to FIGS. 2 and 4, in one embodiment, public access level 210 and 401 access requires authenticated access by scanning indicia 112 and then entering unique patient identifier or public access identifier 114 found on patient tag 113 or 301. After indicia 112 and unique patient identifier 114 are authenticated, the access agent can now have the patient's “public” health information that can assist in proper diagnosis and treatment.

In this embodiment, the requirement to enter public access identifier 114 after scanning indicia 112 is to ensure that public access identifier 114 is not sent over a non-secure internet connection. That is, after the system establishes a secure connection, the system enables the user to enter unique patient access identifier 114. This protects against a “man in the middle” attack on the internet from a remote attacker “snooping” the system's website for internet packets containing the patient's unique patient identifier.

While patient tag 113 does have all the information to log-in to the patient's public access level 401, patient tag 113 does not enable access to any higher security level such as, but not limited to health care provider access level 211, 402, private access level 212, 403 or administrative access level 213, 404. Therefore, public information is protected by single factor authentication 405. That is, public information is protected by something a user (e.g., patient) has such as a patient tag 113 with indicia 112 and public access identifier 114). In one embodiment, any access to the more sensitive EPHIs requires either a valid national provider identifier 406 (NPI) or private access identifier 407 or administrative access identifier 408.

Preferably, information accessed in public access level 401 includes information the patient would normally disclose to anyone in the public 409 in the event of a medical emergency to assist others in helping the patient get proper medical care. Public components 210 of the EPHI can include, but are not limited to, patient name, age, medical conditions, emergency contacts, medication and allergies.

In one embodiment, anytime there is any access to system 100, access parameters 501 (e.g., access device, access device frequency, access level, access time and other information) are recorded in system's log 502 and patient's access log 503. These logs can be used in the system's manual audit and automated security audits, automated security actions and EPHI dissemination forensics.

### Health Care Provider Access Level

In one embodiment, in response to scanning the indicia and then entering: (a) the public access identifier; and (b) an additional identifier, the system enables access to the health care provider access level. For example, in one embodiment, to access health care provider access level 402, system 100 requires two factor authentication. For example, in one embodiment, health care provider access level 402 access requires: (a) something a user (e.g., a patient) has such as patient tag 113 with indicia 112 and unique patient identifier 114; and (b) something a user (e.g., a health care provider) knows such as a National Provider Identifier (NPI) 406, as defined in HIPAA. In this example, access agent or health care provider can now have the critical patient health information needed to make proper diagnosis and treatment in a time critical manner.

In one embodiment, after authentication to public access level 401, system 100 enables the access agent (e.g., a health care provider) to enter their NPI number 406 to enable health care provider access.

In one embodiment, once NPI number 406 is validated against a national database or the patient's health care provider authorized access database 504, system 100 provides additional NPI authorized information 211 EPHI based on the patient's access control settings 204 for the additional information at that level. In one embodiment, system 100 provides the additional NPI authorized information by determining whether the entered NPI number 406 is included in a national database or the patient's health care provider authorized access database 504. In one embodiment, the additional information may include information regarding past procedures, test results, advanced directives, etc. which would be unavailable at the public access level.

In one embodiment, the NPI access parameters are recoded into the system's log 502 and patient's access log 503.

### Private Access Level

In one embodiment, in response to scanning the indicia and then entering a private access identifier, the system enables access to the private access level. For example, in one embodiment, private access level 403 requires authenticated access by scanning indicia 112 from patient tag 113 and entering private access identifier 407 which is known by user 411 (e.g., access agent, patient 105, emergency contact person, trusted friend and/or trusted relative). The requirement to enter private access identifier 407 after scanning indicia 113 is to ensure that private access identifier 407 is not sent over a non-secure internet connection. In one embodiment, private level access 403 requires two factor authentications. For example, in one embodiment, private access level 403 requires: (a) something you have (e.g., indicia 112 on patient tag 113); and (b) something you know (e.g., private access identifier 407). Authentication of the entered access identifier with private access identifier 407 defined by the patient while in the administrative access level 404 is performed to enter into private access level 403.

In one embodiment, in response to private access level 403 being accessed, system 100 provides additional EPHI based on the patient's access control settings. For example, in one embodiment, at the private access level 403, system 100 provides additional private EPHI 212 based on patient's access control settings 204. In one embodiment, the additional private EPHI 212 includes, but is not limited to, a social security number, credit card number, billing information, etc.

Private access identifier 407 is preferably not entered into system's log 502 and patient's access log 503. Preferably, only an indication that a private access was made along with additional access parameters 501. This protects the private access identifier from being copied from the logs.

### Administrative Access Level

In one embodiment, in response to scanning indicia 112 and then entering administrative access identifier 408, system 100 enables access to administrative access level 404. In one embodiment, administrative access level 404 requires authenticated access by scanning indicia 112 from patient tag 113 and entering administrative access identifier 408 known by the access agent. The requirement to enter administrative access identifier 408 after scanning indicia 112 is to ensure that administrative access identifier 408 is not sent over a non-secure internet connection. In one embodiment, administrative access level 404 requires two factor authentications. For example, in one embodiment, access to administrative access level 404 requires: (a) something you have (e.g., indicia 112 on patent tag 213); and (b) something you know (e.g., administrative access identifier 408 or optional USB security token). In one embodiment, authentication of the entered administrative access identifier with the administrative access identifier defined by the patient while in the administrative level is performed to enter into the administrative level.

In one embodiment, at the administrative access level 404, system 100 provides all the EPHI of the patient to the access device.

Preferably, administrative access identifier 408 is not entered into system's log 502 and patient's access log 503, but a record is entered into the logs indicating that an administrative access was made along with additional access parameters. This protects administrative access identifier 408 from being copied from the logs.

Changing the Access Levels

In one embodiment, administrative access level 404 is the only level where EPHI can be added, changed or deleted. While adding information into the EPHI database, access control settings 204 are also entered to enable the patient to control the dissemination of components of the EPHI at the various access levels. For example, in one embodiment, while in the administrative access level, the following access identifiers can be set: the public access identifier; the private access identifier; and the administrative access identifier. In one embodiment, authorized NPIs 504 are entered into the EPHI database in the event that system 100 cannot validate the NPI over a National Online Database Validation method established by HIPAA.

### Security Feature

In one embodiment, system 100 provides additional security through an automated security auditor (ASA). In this example, the ASA monitors the system logs looking for repeated failed attempts to access the system within a certain period of time or other parameters.

Failed attempts are logged in a failed access log that is correlated with the associated failed access to a patient's page access. Multiple attack parameters (e.g., source, location, time, occurrence and others) are measured and analyzed to predict the probability of an attackers attempt to gain unauthorized access to the system. Once a predefined set of attack parameters are met, an attack trigger alerts the system administrator and the patient by voice, text or email communication. The attack parameters are then set to a more stringent set of parameters for a limited period of time. If the attack parameters are met for the second time within that limited period of time, an attack notification is sent out to the system administrator and patient by voice, text or email communication. This system is placed under attack mode. Once in the attack mode, the system alerts the system administrator and the patient by voice, text or email communication.

In one embodiment, system 100 is configured to generate a plurality of security alerts and notifications based on violations of a plurality of parameters set by system 100. The parameters of the ASA can be dynamically changed as the system detects attacks.

While in attack mode, authentication access to the patient's page is temporarily stopped for a cooling off period. During this period any requests made to the patient's page can not be responded to. The length of the cooling off period is determined by the system administrator and is communicated to the patient by voice, text or email communication. Once the cooling off period has expired and an acceptable number of accesses have been made, the system falls back to an attack trigger mode and a message is sent out to the system administrator and patient by voice, text or email communication. If while in the attack trigger mode, no attack parameters are met, then the system reverts back to its normal operation and a message is sent out to the system administrator and patient by voice, text or email communication. If while in the attack trigger mode, the system is forced back into the attack mode multiple times, the system extends the cooling off time and once again alerts the system administrator and patient by voice, text or email communication.

The multilevel attack algorithm prevents the patient from having to reset the operating mode and access identifier provided the attack subsides. The cooling off period extends the time it takes for a brute force attack to succeed.

In one embodiment, the system makes periodic scheduled security audits to ensure that no patient pages are left in the cooling off period longer than the cooling off period.

In one embodiment, in response to an access to administrative access level 404, system 100 checks for a cookie stored on access device 117. In response to system 100 determining there is no cookie, system 100 sends a temporary administrative access identifier to the patient's primary email account to ensure that the patient authorizes access on a new access device.

Once the access agent has authenticated access, based on the type of access device being used, system 100 can select the appropriate display format for the appropriate access device (e.g., smartphone, tablet, or PC). The authorized level of patient's EPHI is then provided with the appropriate resolution to the access device. The information can then be viewed (or updated at the administrative level) by commands understood by the access device's browser controls. These controls typically include panning, scrolling and zooming. The information is grouped and displayed in a way that is simple to read and understand based on the access level granted. The display format can dynamically vary based on the information enabled the patient at the access Level.

In one embodiment, in additional to general health information, system 100 stores health care related appointments. System 100 can then send out messages by way of voice, text or emails to remind the patient of upcoming appointments. If the patient uses a smartphone, a map can be loaded and if the patient's access device has the capability of navigation, and working in conjunction with the navigation App, the access device can provide directions to the health care facility site.

In one embodiment, system 100 enables user 105 (e.g., patient) to enter information regarding medication such as medication strength and dose, doctor and pharmacy contact information, prescription number, refill date and number of refills to assist the patient in the management of the medication. Voice, text and email communication with user 105 can assist in ensuring that medication is taken on time and refills are ordered in a timely manner.

For patients with a smartphone or tablet, a companion application is available that can securely communicate with the system located on the cloud so that doctors, pharmacies and health care providers contact information is made available on the patients phone contact list. The patient's calendar and alarms can be set to further assist in reminding the patient of critical events that need to happen.

In one embodiment, system 100 uploads additional patient records 505 to the patient's EPHI. This information can be stored and retrieved as an individual health document. In one embodiment, system 100 supports document, photo, and video file format such as, but not limited to .doc, .docx, .xls, .xlsx, .pdf, WMV, flash, .gif, .pt, .pptx, .txt, .jpg, .MOV, .MP3, or .MP4. In one embodiment, access device 117 includes document readers and media players to render a display on the access device. Preferably, these types of files include test results from labs such as, but not limited to, blood test, reports from outpatient procedures such as, but not limited to, Angiograms, X-Rays, Sonograms, etc. Storage of these records provides the patient a safe and secure way to maintain an archive of these documents. These documents can then be made available to other health care providers should the patient choose to select a new provider. These records can be tagged with providers NPI 506 to ensure traceability. These files can also be sent directly to the patients EPHI files simply by fax or secure emailing to the system with the providers NPI as defined by HIPAA. The patient is then notified by a voice, text or email communication that a record has been received. The patient can review the file and accept or deny the document. In either case the system and patient logs can be updated that a file has been sent. The system and patient logs only maintain that an authorized access was made. The actual files are only retained if the patient accepts the submissions, then they are only retained in the Patient's EPHI.

In one embodiment, system 100 includes a random number generator (e.g., an online Global Unique Identifier Generator, or similar generator). In one embodiment, the random number generator is seeded with a random number. The random generator then provides a statistically unique integer to identify the patient to system 100. This patient identifier is later used to link to patient database 101. Statistically unique integer 107 is appended to the system's web site URL address 111 and directory path 106. The complete URL is then fed in to an indicia generator (e.g., quick response code generator) to make indicia 112 that is unique to the patient.

The website employed by the system can be written in various tools such as C#, HyperText Markup Language (HTML), LAMP (software, referring to the first letters of Linux (operating system), Apache HTTP Server, MySQL (database software) and PHP (or sometimes Perl or Python)), web frameworks such as Ruby on Rails (ROR) uses the Model-View-Controller (MVC) architecture pattern to organize web application programming or other software development tools with principal components to build a viable general purpose web server to provide a unique patient portal. This portal must be secured via SSL or TLS. The site must provide password protection prior to entry and manage the plurality of security access levels previously described herein. Once the web site is completed it can be hosted on the Cloud.

In one embodiment, patient tag 113 includes indicia and a unique patient identifier which does not use the clear slot for a replaceable patient access ID. In this embodiment, changing the patient access identifier would require a replacement patient tag.

In one embodiment, access device 117 is configured to simultaneously read indicia 112 and a unique identifier indicia. After a secure link is established, the second indicia could provide the unique patient identifier for simplified access as the healthcare provider would not have to enter in a human readable patient ID. In one embodiment, this configuration is employed by the access device in response to the download of a customized application.

In one embodiment, an automated security auditor program is used to automatically detect, inhibit and reset access to accounts without having an administrator intervene. This feature can improve the security of the system and reduces system manual monitoring and maintenance.

In one embodiment, where system 100 employs a cloud, the arrangement of web and database servers or a group of servers or a server, or a group of servers can provide: (a) an on-demand scalability of highly available and reliable pooled computing resources; (b) secure access to metered services from nearly anywhere; (c) and dislocation of data from inside to outside the organization.

In one embodiment, system 100 resides on a dedicated server or group of servers on company site with its own security and backup systems.

In one embodiment, the web server and database server resides in a single server.

In one embodiment, the web server and database server reside in a virtualized server running with other applications concurrently.

In one embodiment, access levels are arranged differently to provide for more or less security levels or security levels that are parallel in level of security but provide a different plurality of health information.

In one embodiment, access device 117 includes a preloaded scanner application. Referring to FIG. 1, in one example, access device 117 includes preloaded indicia scanner application 124. In one embodiment, preloaded indicia scanner application 124 is downloaded from existing online market places or application stores 125 accessible through the network or internet. These “Scanner Apps” use the integrated camera technology in the access device to scan the uniquely generated indicia 112 and open a secure website containing patient's page 108 through a commercially available wired or wireless network providing quick access to the Patient's EPHI.

Access to the system is though secure web server 119 protected by secure sockets layer (SSL) 118, a protocol for transmitting private documents on the Internet web service. SSL or transport layer security (TLS) or other internet security methods are used to protect confidential information over the internet by encrypting the information with a unique session key established using asymmetric cryptography.

In one embodiment, in response to the system authenticating the access device, the access device displays a visual display of the patient's facial image to help the access agent ensure the patient tag belongs to the patient. In one embodiment, the patient's facial image is one of the pluralities of information uploaded in the system by the patient at administrative level at the patient's discretion.

System can be used for securing and retrieving a history of information that needs to be accessible easily and quickly. Access to confidential or otherwise valuable information could be based on a person (health information, travel documents, credit information, and ticketed events), locations (museums, National Parks or Grave Markers) or object (art pieces, auction items, or collectibles).

In one embodiment, the patient tag includes a travel tag (e.g., a driver's license). In this embodiment, if the traveler become unconscious, non-responsive or have amnesia, using the travel tag, a government official (e.g., a police officer) could help in the identification of identity, travel itinerary or contact information of the traveler. The traveler tag can be a component of a Passport or Visa. In one embodiment, security levels are controlled by the traveler, government authority or travel agent. Related information is securely stored to be retrieved by others while ensuring that traveler is in their presence.

In one embodiment, the patient tag includes a sport tag. In this embodiment, if a sportsperson (e.g., runner, mountain climber or tri-athlete) become unconscious, non-responsive or have amnesia, the system enables a person (e.g., an event manager, fellow sportsperson, etc.), using the sport tag, to help in the identification of identity, travel itinerary, health history or contact information.

In one embodiment, the patient tag includes a processing tag. In this embodiment, the indicia and unique patient identifier can be used to track the processing or movement of a person or item. In one example, the processing tag may used in an environment where a building having different access points. In this example, a first access device located at a first access point would scan the indicia located on the user. After entering a unique identification for the user, and being properly authenticated, a new unique identifier can be generated at the first access point. The new unique identifier can be used by the user to enter a second access point. Scanning the indicia and entering in the unique public identifier would ensure that the person or item has been processed. By requiring having a smartphone or access device and a human readable processing identifier ensures that the person or item has been seen by a machine or computer as well as a human. Various processing private identifiers can be used to update the processing history in the process database on the cloud or on a company intranet.

In one embodiment, the patient tag includes a login tag (e.g., an employee badge). In this embodiment, a custom application running on the access device can read indicia on the login tab through the access device's built in camera. After the camera automatically reads the indicia, the system enables an employee to type in a private identifier to gain access to company resources.

In one embodiment, the patient tag is used on a grave marker. The indicia and unique public identifier could be etched, engraved of otherwise permanently attached to the grave marker. Visitors could then use their smartphone or access device to scan the indicia and enter in the public identifier to view a public eulogy or relatives or close friends could enter is a private identifier passed down from generations for a more detail and private eulogy. The patient page could have a link to other information such as ancestry tracking sites to show their heritage. All available while visitors are at the grave site and have Internet access.

The access tag (i.e., patient tag) could uniquely be reprinted each time there is an access and change the access identifier to a new identifier for the next access point. The re-printing in the access tags would invalid any copies made of the access tag and assist is capturing imposters. The new access identifier is saved by the system and the progressions of access identifier are logged in the database.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An emergency response health information system comprising:
a patient tag including: (a) an indicia; and (b) a unique patient identifier;
an access device; and
an information processing system configured to communicate with the access device, the access device including:
(a) a first processor;
(b) a reading device operatively coupled to the first processor;
(c) a first input device operatively coupled to the first processor; and
(d) a first memory device storing first instructions which when executed by the first processor, cause the first processor, in cooperation with the reading device, the first input device and the first memory device, to:
(i) read the indicia and transmit the indicia to the information processing system;
(ii) after a secure connection is established between the access device and the information processing system, enable a user to enter a unique patient identifier; and
(iii) transmit the entered unique patient identifier to the information processing system; and
the information processing system including:
(a) a second processor; and
(b) a second memory device storing second instructions which when executed by the second processor, cause the second processor, in cooperation with the second memory device, to, after the entered unique patient identifier has been transmitted, transmit, to the access device, a first health information component.

2. The emergency response health information system of claim 1, wherein:
(a) the indicia includes a Uniform Resource Locator (URL) and a directory structure; and
(b) the unique patient identifier is a readable set of alpha-numeric characters.

3. The emergency response health information system of claim 1, wherein the reading device includes a camera.

4. The emergency response health information system of claim 1, wherein the first health information component includes at least one of name, height, weight, age, phone number, address, emergency contact, medical conditions, medication, allergies, primary and specialist physicians, procedures, operations, test results, advanced directives, family history, health history, cognitive and perceptional limitations, nutrition/metabolic concerns, values/beliefs/spiritual care.

5. The emergency response health information system of claim 1, wherein the second instructions, when executed by the second processor, cause the second processor, in cooperation with the access device, to:
(a) enable the user to enter a second identifier, the second identifier being different from the unique patient identifier; and
(b) in response to the second identifier being authenticated, provide, to the access device, a second health information component, the second health component being different from the first health information component.

6. The emergency response health information system of claim 5, wherein the second identifier includes an administrative access identifier.

7. The emergency response health information system of claim 5, wherein the second health component includes information regarding at least one of past procedures, test results, and advanced directives.

8. A method of operating an emergency response health information system, the method comprising:
(a) causing an access device to read indicia from a patient tag and transmit the indicia to an information processing system;
(b) after establishing a secure connection the access device and the information processing system, enabling a user to enter a unique patient identifier which is located on the patient tag;
(c) causing the access device to transmit the entered unique patient identifier to the information processing system; and
(d) after the entered unique patient identifier has been transmitted, causing the information processing system to transmit, to the access device, a first health information component.

9. The method of claim 8, wherein:
(a) the indicia includes a Uniform Resource Locator (URL) and a directory structure; and
(b) the unique patient identifier is a readable set of alpha-numeric characters.

10. The method of claim 8, wherein the first health information component includes at least one of name, height, weight, age, phone number, address, emergency contact, medical conditions, medication, allergies, primary and specialist physicians, procedures, operations, test results, advanced directives, family history, health history, cognitive and perceptional limitations, nutrition/metabolic concerns, values/beliefs/spiritual care.

11. The method of claim 8, which includes:
(a) causing the access device to enable the user to enter a second identifier, the second identifier being different from the unique patient identifier; and
(b) in response to the second identifier being authenticated, causing the information processing system to provide, to the access device, a second health information component, the second health component being different from the first health information component.

12. The method of claim 11, wherein the second identifier includes an administrative access identifier.

13. The emergency response health information system of claim 11, wherein the second health component includes information regarding at least one of past procedures, test results, and advanced directives.

14. An access device comprising:
a first processor;
a reading device operatively coupled to the first processor;
a first input device operatively coupled to the first processor; and
a first memory device storing instructions which when executed by the first processor, cause the first processor, in cooperation with the optical scanner, the first input device and the first memory device, to:
(a) read an indicia from a patient tag;
(b) transmit the indicia to an information processing system;
(c) after a secure connection is established between the access device and the information processing system, enable a user to enter a unique patient identifier;
(d) transmit the entered unique patient identifier to the information processing system; and
(e) receive, from the information processing system, a first health information component.

15. The access device of claim 14, wherein:
(a) the indicia includes a Uniform Resource Locator (URL) and a directory structure; and
(b) the unique patient identifier is a readable set of alpha-numeric characters.

16. The access device of claim 14, wherein the reading device includes a camera.

17. The access device of claim 14, wherein the first health information component includes at least one of name, height, weight, age, phone number, address, emergency contact, medical conditions, medication, allergies, primary and specialist physicians, procedures, operations, test results, advanced directives, family history, health history, cognitive and perceptional limitations, nutrition/metabolic concerns, values/beliefs/spiritual care.

18. The access device of claim 14, wherein the information processing system if configured to operate with the access device to:
(a) enable the user to enter a second identifier, the second identifier being different from the unique patient identifier; and
(b) in response to the second identifier being authenticated, provide, to the access device, a second health information component, the second health component being different from the first health information component.

19. The access device of claim 18, wherein the second identifier includes an administrative access identifier.

20. The access device of claim 18, wherein the second health component includes information regarding at least one of past procedures, test results, and advanced directives.
